(19) United States
(12) Patent Application Publication
(10) Pub. No.: US 2025/0294347 A1
(43) Pub. Date: Sep. 18, 2025

(54) AUTHENTICATION SYSTEM FOR A VEHICLE FOR AUTHENTICATING PORTABLE AUTHENTICATION DEVICES AND ASSOCIATED METHOD

(71) Applicant: MARQUARDT GMBH, Rietheim-Weilheim (DE)

(72) Inventors: Bernd BAER, Rottweil (DE); Joerg FISCHER, Donaueschingen (DE); Antoine BACLE, Chauray (FR); Fabian FURTWAENGLER, Loeffingen (DE); Andreas KOCH, Rietheim-Weilheim (DE)

(21) Appl. No.: 18/861,492

(22) PCT Filed: Aug. 30, 2023
(86) PCT No.: PCT/EP2023/073786

§ 371 Date: Oct. 29, 2024

(30) Foreign Application Priority Data
Sep. 27, 2022 (DE) 10 2022 124 868.2

(51) Int. Cl. H04W 12/06; H04W 4/48; H04W 4/80; H04W 12/50

(52) U.S. Cl. CPC H04W 12/06; H04W 4/48; H04W 4/80; H04W 12/50

(57) ABSTRACT

An authentication system for a vehicle for authenticating a number of portable authentication devices to the vehicle has at least one BLE module having at least one BLE antenna and a control unit for controlling the BLE antenna The control unit operates the BLE module alternately in a first operating mode and a second operating mode (B), wherein the BLE module in the first operating mode establishes a connection in a scanning role with at least one portable authentication device which works in an advertising role, and wherein the BLE module in the second operating mode establishes a connection in an advertising role with at least one portable authentication device which works in a scanning role.

The invention relates to an authentication system for a vehicle for authenticating a number of portable authentication devices to the vehicle for enabling vehicle functions for an operator who in particular carries one or multiple portable authentication devices. The invention further relates to a method for operating the authentication system.

When using Bluetooth Low Energy (BLE) to connect two components or modules, it is necessary that one of the modules works as an advertiser or in an advertising role, and the other module works as a scanner or in a scanning role.

Regarding authentication systems for vehicles, it is usually provided that the vehicle has a BLE module operating in an advertising role to connect to a portable authentication device which has a BLE module operating in a scanning role.

If the vehicle is also intended to be able to connect to portable authentication devices that work in an advertising role, the prior art has so far mostly provided for the vehicle to comprise two BLE modules, one of which works in an advertising role and the other in a scanning role.

However, this leads to increased costs due to the additional module.

The object of the invention is therefore to overcome the aforementioned disadvantages and provide an authentication system which can connect both to a portable authentication device in the scanning role and to a portable authentication device in the advertising role. This object is achieved by the combination of features according to claim 1.

According to the invention, an authentication system for a vehicle is provided for authenticating a number of portable authentication devices to the vehicle, in particular for enabling vehicle functions for an operator who in particular carries at least one of the portable authentication devices. The portable authentication device(s) are preferably ID transmitters. For this purpose, the authentication system has at least one and preferably exactly one BLE module, which can also be called a BLE anchor. The BLE module has at least one BLE antenna and a control unit for controlling the BLE antenna, or for operating the BLE antenna. The control unit is designed to operate the BLE module alternately in a first operating mode and a second operating mode. Furthermore, the control unit is designed to operate the BLE module in the first operating mode to establish a connection in a scanning role with at least one (first) portable authentication device operating in an advertising role, and to operate the BLE module in the second operating mode to establish a connection in an advertising role with at least one (second) portable authentication device operating in a scanning role.

The control unit, as part of the BLE module, can be an ECU. Alternatively, the entire BLE module can also be an ECU with an integrated BLE antenna.

Preferably, the BLE module has exactly one BLE antenna, which can be operated alternately in the advertising role and the scanning role according to the respective operating mode.

One advantageous development provides that the control unit is designed to operate the BLE module for a first predetermined period of time in the first operating mode and to operate the BLE module for a second predetermined period of time in the second operating mode.

The first period of time can be the same as the second period of time.

Alternatively, however, the first and second period of time may differ from one another and may, for example, be tailored to a number of portable authentication devices connected to the authentication system in the respective operating mode. In such a variant, it is preferably provided that the first period of time corresponds to and preferably correlates to a number of portable authentication devices connected or communicating with the BLE module in the first operating mode. Additionally or alternatively, the second period of time may correspond and preferably correlate to a number of portable authentication devices connected or communicating with the BLE module in the second operating mode.

In this case, for example, even if no portable authentication devices are connected or communicating, the first period of time and/or the second period of time may correspond to a minimum value to which a predetermined value is added for each connected portable authentication device.

If the portable authentication devices are part of the authentication system, it can be provided that the number of portable authentication devices comprises a first subset and a second subset, wherein the first subset comprises portable authentication devices operating in the advertising role and the second subset comprises portable authentication devices operating in the scanning role or consists of these.

A further aspect of the invention relates to a method for operating an authentication system according to the invention. According to the method, the BLE module is operated alternately in the first operating mode and the second operating mode.

In the method, it is preferably provided that the BLE module in the first operating mode operates in a scanning role in which advertising events are received to establish the connection, and/or that the BLE module in the second operating mode operates in an advertising role in which advertising events are sent to establish the connection.

Furthermore, in the first operating mode, a first number of portable authentication devices connected to the BLE module can be detected and a first period of time can be determined therefrom, wherein the BLE module is operated in the first operating mode for the first period of time. Additionally or alternatively, in the second operating mode, a second number of portable authentication devices connected to the BLE module can in a similar manner be detected and a second period of time can be determined therefrom, wherein the BLE module is operated in the second operating mode for the second period of time.

The features disclosed above can be combined in any way as long as such combination is technically feasible and said features do not contradict one another.

Other advantageous developments of the invention are characterized in the dependent claims and will be described in greater detail in the following, in conjunction with the description of the preferred embodiment of the invention with reference to the figures. In the figures:

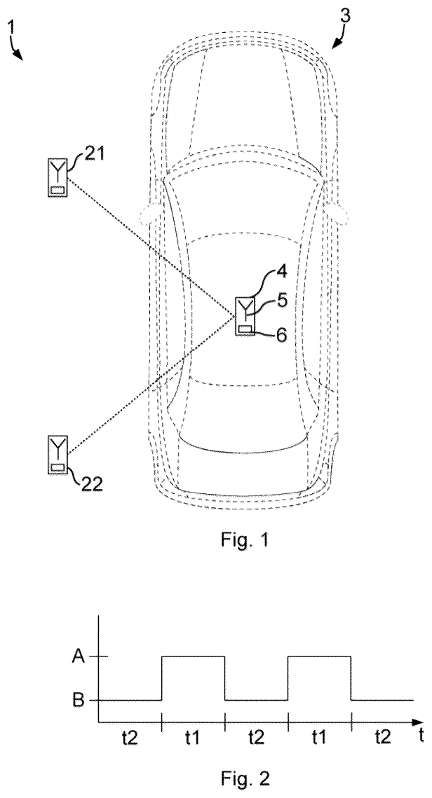

FIG. 1 shows a schematically illustrated authentication system;

FIG. 2 shows a transition between the operating modes.

The figures show schematic examples. Same reference numerals in the figures denote same functional and/or structural features.

FIG. 1 shows an example of an authentication system 1 of a vehicle 3, which is connected to or can establish a connection to two portable authentication devices 21, 22 designed as portable ID transmitters. A first ID transmitter 21 operates in an advertising role, and a second ID transmitter 22 operates in a scanning role.

In order to be able to connect to both ID transmitters 21, 22 on the vehicle side, exactly one BLE module 4 is provided instead of two separate BLE modules, which one module has at least one or exactly one BLE antenna 5 and a control unit 6 for controlling the BLE antenna 5.

In order to be able to communicate or connect with both the first ID transmitter 21 and the second ID transmitter 22 using a single BLE module, it is provided that the BLE module 4—as shown in FIG. 2—is operated alternately for a first period of time t1 in a first operating mode A, and operated for a second period of time t2 in a second operating mode B. Alternatively, the operating modes can also be achieved by a BLE IC with two receive/transmit channels.

The BLE module 4 operates in the first operating mode A to establish a connection in a scanning role with the first ID transmitter 21 operating in the advertising role, and operates in the second operating mode B to establish a connection in a scanning role with the second ID transmitter 22 operating in the scanning role.

1. An authentication system (1) for a vehicle (3) for authenticating a number of portable authentication devices (21, 22) to the vehicle (3),
the system comprising at least one BLE module (4) having at least one BLE antenna (5) and a control unit (6) for controlling the BLE antenna (5),
wherein the control unit (6) is designed to operate the BLE module (4) alternately in a first operating mode (A) and a second operating mode (B),
wherein the control unit (6) is designed to operate the BLE module (4) in the first operating mode (A) to establish a connection in a scanning role with at least one portable authentication device (21) operating in an advertising role,
and wherein the control unit (6) is designed to operate the BLE module (4) in the second operating mode (B) to establish a connection in an advertising role with at least one portable authentication device (22) operating in a scanning role.

2. The authentication system according to claim 1,
wherein the BLE module (4) has at least one or in particular exactly one BLE antenna (5), which can be operated alternately in the advertising role and the scanning role.

3. The authentication system according to claim 1,
wherein the control unit (6) is designed to operate the BLE module (4) for a first predetermined period of time (t1) in the first operating mode (A), and operate the BLE module for a second predetermined period of time (t2) in the second operating mode (B).

4. The authentication system according to claim 3, wherein the first period of time (t1) is equal to the second period of time (t2).

5. The authentication system according to claim 3,
wherein the first period of time (t1) corresponds to a number of portable authentication devices (21) connected to the BLE module (4) in the first operating mode (A)
and/or wherein the second period of time (t2) corresponds to a number of portable authentication devices (22) connected to the BLE module (4) in the second operating mode (B).

6. The authentication system according to claim 1,
wherein the number of portable authentication devices comprises a first subset and a second subset, wherein the first subset comprises portable authentication devices (21) operating in the advertising role, and the second subset comprises portable authentication devices (22) operating in the scanning role.

7. A method for operating an authentication system according to claim 1,
wherein the BLE module (4) is operated alternately in the first operating mode (A) and the second operating mode (B).

8. The method according to claim 1,
wherein the BLE module (4) in the first operating mode (A) operates in a scanning role in which advertising events are received to establish the connection,
and/or the BLE module (4) in the second operating mode (B) operates in an advertising role in which advertising events are sent to establish the connection.

9. The method according to claim 1,
wherein, in the first operating mode (A), a first number of portable authentication devices (21) connected to the BLE module (4) is detected and a first period of time (t1) is determined therefrom, wherein the BLE module (4) is operated in the first operating mode (A) for the first period of time (t1),
wherein, in the second operating mode (B), a second number of portable authentication devices (22) connected to the BLE module (4) is detected and a second period of time (t2) is determined therefrom, wherein the BLE module (4) is operated in the second operating mode (B) for the second period of time (t2).
